(19) United States
(12) Patent Application Publication
(10) Pub. No.: US 2026/0050904 A1
(43) Pub. Date: Feb. 19, 2026

(54) SYSTEMS AND METHODS FOR LOCATION DEPENDENT INSTANTANEOUS RESOURCE MANAGEMENT

(71) Applicant: BANK OF AMERICA CORPORATION, Charlotte, NC (US)

(72) Inventors: Tanuja Krishna Naik, Davidson, NC (US); Carlos Francisco Curiel, Matthews, NC (US); Gerard Gay, Seattle, WA (US); Lefkothea Hadjiloucas, Edison, NJ (US); Anna Mirarchi, Charlotte, NC (US); Rahul Kumar Mishra, Skillman, NJ (US); Maharaj Mukherjee, Poughkeepsie, NY (US); Elvis Nyamwange, Little Elm, TX (US)

(73) Assignee: BANK OF AMERICA CORPORATION, Charlotte, NC (US)

(21) Appl. No.: 18/803,134

(22) Filed: Aug. 13, 2024

(51) Int. Cl. G06Q 20/22; G06Q 10/02; G06Q 20/32; G06Q 20/40; H04W 4/029

(52) U.S. Cl. CPC G06Q 20/227; G06Q 10/025; G06Q 20/3224; G06Q 20/3229; G06Q 20/405; H04W 4/029

(57) ABSTRACT

Systems, computer program products, and methods are described herein for location dependent instantaneous resource management. The present disclosure is configured to receive a user itinerary, wherein the user itinerary comprises a destination of a user; determine a real-time user location using a synchronized travel engine (STE); determine the user has arrived at the destination; generate a temporary account, wherein the temporary account is generated using the STE, and wherein the temporary account is generated based on local regulations of the destination; configure the temporary account to be communicatively coupled with at least a main account associated with the user; configure the user device to access the temporary account; and remove, in response to the user location leaving the destination, the temporary account, wherein removing the temporary account comprises deleting the temporary account and decoupling the temporary account from the main account.

### TECHNOLOGICAL FIELD

Example embodiments of the present disclosure relate to systems and methods for location dependent instantaneous resource management.

### BACKGROUND

There are significant challenges associated with instantaneous resource management. Applicant has identified a number of deficiencies and problems associated with conventional ways to manage resources. Through applied effort, ingenuity, and innovation, many of these identified problems have been solved by developing solutions that are included in embodiments of the present disclosure, many examples of which are described in detail herein.

### BRIEF SUMMARY

The following presents a simplified summary of one or more embodiments of the present disclosure, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

Systems, methods, and computer program products are provided for location dependent instantaneous resource management.

Embodiments of the present invention address the above needs and/or achieve other advantages by providing apparatuses (e.g., a system, computer program product, and/or other devices) and methods for location dependent instantaneous resource management. The system embodiments may comprise a processing device and a non-transitory storage device containing instructions when executed by the processing device, to perform the steps disclosed herein. In computer program product embodiments of the invention, the computer program product comprises a non-transitory computer-readable medium comprising code causing an apparatus to perform the steps disclosed herein. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the steps disclosed herein.

In some embodiments, the present disclosure receives a user itinerary, wherein the user itinerary includes a destination of a user. In some embodiments, the present disclosure determines a user location using a synchronized travel engine (STE), wherein the user location includes a real time geolocation of a user device associated with the user. In some embodiments, the present disclosure determines, based on the user location, the user has arrived at the destination. In some embodiments, the present disclosure generates, in response to the user location being within the destination, a temporary account, wherein the temporary account is generated using the STE, and wherein the temporary account is generated based on local regulations of the destination. In some embodiments, the present disclosure configures the temporary account to be communicatively coupled with at least a main account associated with the user. In some embodiments, the present disclosure configures the user device to access the temporary account. In some embodiments, the present disclosure removes, in response to the user location leaving the destination, the temporary account, wherein removing the temporary account includes deleting the temporary account and decoupling the temporary account from the main account.

In some embodiments, the present disclosure may receive the user itinerary, wherein the user itinerary comprises a second destination of the user. In some embodiments, the present disclosure may determine, based on the user location, the user has arrived at the second destination. In some embodiments, the present disclosure may generate, in response to the user location being within the second destination, a second temporary account, wherein the second temporary account is generated using the STE, and wherein the second temporary account is generated based on local regulations of the second destination. In some embodiments, the present disclosure may configure the second temporary account to be communicatively coupled with at least the main account associated with the user. In some embodiments, the present disclosure may configure the user device to access the second temporary account. In some embodiments, the present disclosure may remove, in response to the user location leaving the second destination, the second temporary account, wherein removing the second temporary account comprises deleting the second temporary account and decoupling the second temporary account from the main account.

In some embodiments, the present disclosure may receive an updated user itinerary, wherein the updated user itinerary comprises a new destination of the user. In some embodiments, the present disclosure may determine, based on the user location, the user has arrived at the new destination. In some embodiments, the present disclosure may generate, in response to the user location being within the new destination, a new temporary account, wherein the new temporary account is generated using the STE, and wherein the new temporary account is generated based on local regulations of the new destination. In some embodiments, the present disclosure may configure the new temporary account to be communicatively coupled with at least the main account associated with the user. In some embodiments, the present disclosure may configure the user device to access the new temporary account. In some embodiments, the present disclosure may remove, in response to the user location leaving the new destination, the new temporary account, wherein removing the new temporary account comprises deleting the new temporary account and decoupling the new temporary account from the main account.

In some embodiments, generating the temporary account may further include determining local regulations of a domicile of the user, wherein the domicile comprises a home country of the user, and wherein the local regulations of the domicile provide guidance for the temporary account. In some embodiments, generating the temporary account may further include determining local regulations of the destination, wherein the local regulations of the destination provide guidance for the temporary account. In some embodiments, generating the temporary account may further include generating the temporary account based on the local regulations of the domicile and local regulations of the destination.

In some embodiments, the destination may include a country that is different than a domicile of the user, wherein the domicile includes a home country of the user.

In some embodiments, configuring the user device to access the temporary account further includes configuring the temporary account to be secured by one or more security measures, wherein the one or more security measures are the same one or more security measures used to secure the main account.

In some embodiments, the present disclosure may generate a resource transaction list, wherein the resource transaction list is associated with the temporary account and includes the resource transactions performed with the temporary account. Further, in some embodiments, the present disclosure may transmit the resource transaction list to the main account, wherein the main account provides for the user to access the resource transaction list after the temporary account has been removed.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for location dependent instantaneous resource management, in accordance with an embodiment of the disclosure;

FIG. 2 illustrates a process flow for location dependent instantaneous resource management, in accordance with an embodiment of the disclosure; and

FIG. 3 illustrates an example embodiment of the resource management system, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository—a storage location where one or more resources are organized, stored and retrieved electronically using a computing device.

As used herein, a “transfer,” a “distribution,” and/or an “allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

As used herein, “payment instrument” may refer to an electronic payment vehicle, such as an electronic credit or debit card. The payment instrument may not be a “card” at all and may instead be account identifying information stored electronically in a user device, such as payment credentials or tokens/aliases associated with a digital wallet, or account identifiers stored by a mobile application.

In the modern world, instantaneous transfers of money are crucial for maintaining the speed required of present-day transactions. Notably, however, conventional instantaneous resource (e.g., money) transfer systems may fail to include accounts from foreign countries. This leads to issues for individuals traveling in foreign countries. For example, Unified Payments Interface (UPI) used for person-to-person (P2P) and person-to-merchant (P2M) transaction is very convenient for a large population. However, travelers from particular countries, such as the United States, face challenges with conventional systems that are not compatible with United States banking infrastructure. In a specific example, a traveler may face issues with UPI systems in foreign countries that are not compatible with the traveler's own bank account. Therefore, systems and methods for location dependent instantaneous resource management are introduced.

The present disclosure provides for using a synchronized travel engine (STE) to create temporary accounts when a user is traveling in a foreign country and the user's own account is not compatible with otherwise globally accepted instantaneous payment systems, such as UPI. The STE may be activated by a user prior to travel by the user inputting travel dates, an itinerary, a ticket image, or the like. The STE may integrate with the user's bank accounts (e.g., checking and savings account) and have access to Know Your Customer (KYC) data. The STE may execute controls for money transactions while complying with laws, rules, regulations, sanctions (LRRS) for the user's home country as well as LRRS for the destination country. The STE may have the ability to track the user's location using global positioning satellite (GPS) or global system for mobile communication (GSM) satellites to verify user departures and arrivals to the destination country.

Further, the STE may have the ability to identify compatible service providers (e.g., mobile service providers) for destination locations and generate electronic subscriber identity module (e-SIM) cards and virtual money transfer applications compatible with UPI systems at the destination country. The STE may suggest virtual money transfer applications that are approved by the respective local (e.g., destination) governments. The STE, e-SIM cards, and virtual money transfer application may be installed on the user's mobile device (e.g., phone, tablet, computer, etc.) and connect with the user's existing bank accounts. The STE and virtual money application may use the user's biometric data as authentication for money transactions. Further, the user's biometric data may be required for e-SIM card installation and usage. The user may be able to request one or more lines for money transactions.

What is more, the present disclosure provides a technical solution to a technical problem. As described herein, the technical problem includes the lack of integration of instantaneous payment systems for users domiciled in certain countries. The technical solution presented herein allows for enabling travelers (e.g., users) access to global instantaneous payment systems. In particular, a resource management system (e.g., the system 130 as described herein) is an improvement over existing solutions to conventional systems associated with instantaneous money transfers, (i) with fewer steps to achieve the solution, thus reducing the amount of computing resources, such as processing resources, storage resources, network resources, and/or the like, that are being used (e.g., by allowing for a user to transact resources instantaneously when traveling), (ii) providing a more accurate solution to problem, thus reducing the number of resources required to remedy any errors made due to a less accurate solution (e.g., determining which application complies with the user's domicile rules and regulations as well as with the destination country's rules and regulations), (iii) removing manual input and waste from the implementation of the solution, thus improving speed and efficiency of the process and conserving computing resources (e.g., by using the STE to set up the user's temporary account and linking the temporary account to the user's main account), (iv) determining an optimal amount of resources that need to be used to implement the solution, thus reducing network traffic and load on existing computing resources (e.g., using the STE to create the temporary account at the correct point in time when the user arrives at the destination country, and removing the temporary account when the user leaves the destination country). Furthermore, the technical solution described herein uses a rigorous, computerized process to perform specific tasks and/or activities that were not previously performed. In specific implementations, the technical solution bypasses a series of steps previously implemented, thus further conserving computing resources.

In addition, the technical solution described herein is an improvement to computer technology and is directed to non-abstract improvements to the functionality of a computer platform itself. Specifically, the resource management system as described herein is a solution to the problem of conventional systems not allowing users from particular countries to use instantaneous resource management systems. Further, the resource management system may be characterized as identifying a specific improvement in computer capabilities and/or network functionalities in response to the resource management system's integration to existing devices, software, applications, and/or the like. In this way, the resource management system improves the capability of a system to allow a user to transact resources instantaneously via the temporary account. Further, the resource management system improves the functionality of networks in response to reducing the resources consumed by the system (e.g., network resources, computing resources, memory resources, and/or the like).

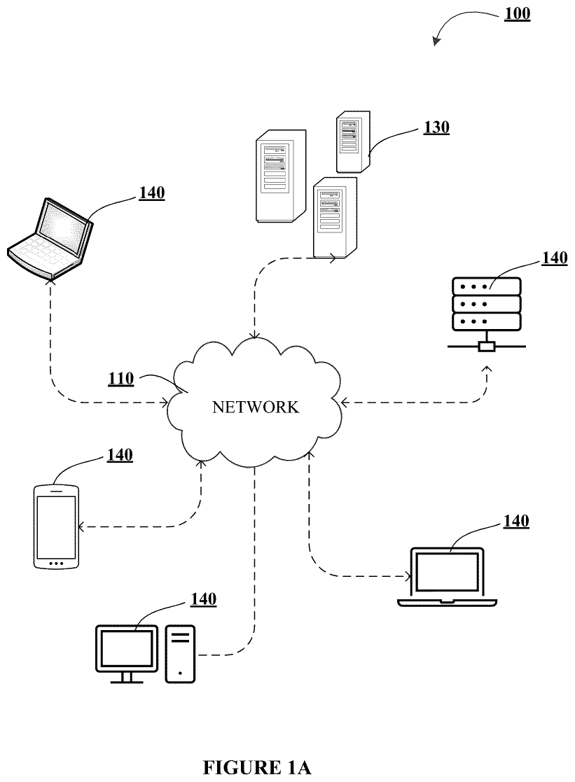

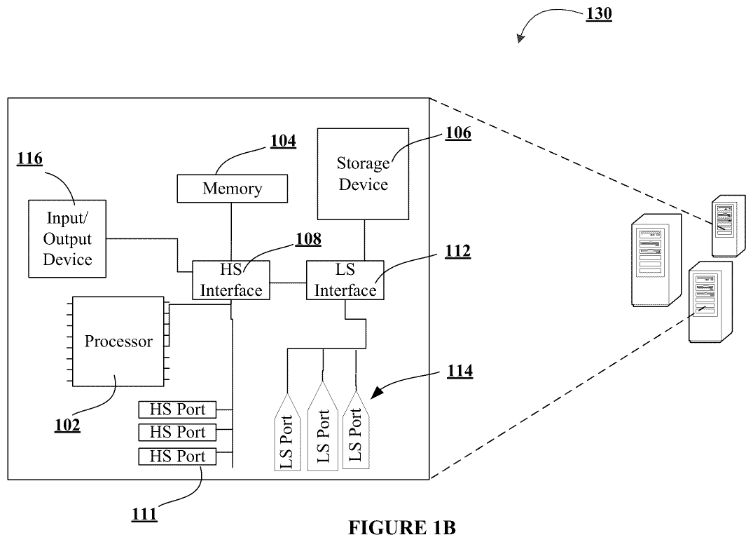

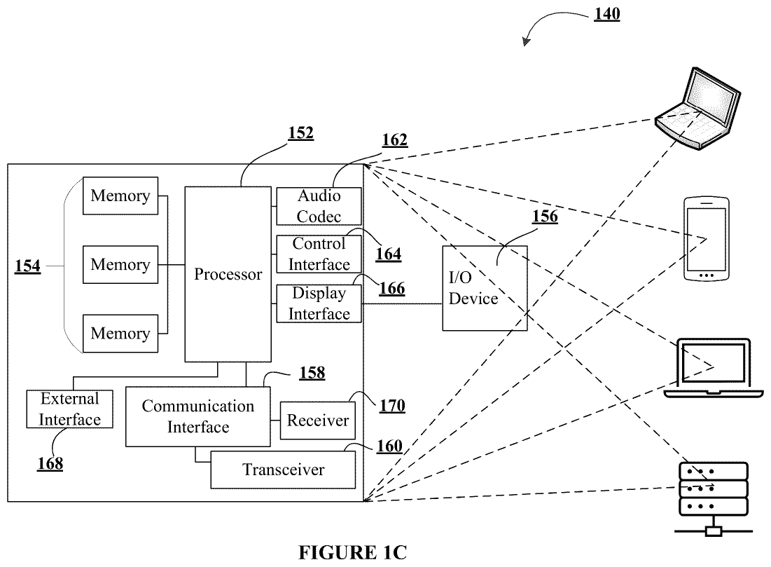

FIGS. 1A-1C illustrate technical components of an exemplary distributed computing environment 100 for location dependent instantaneous resource management, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server (e.g., system 130). In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, resource distribution devices, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. In some embodiments, the network 110 may include a telecommunication network, local area network (LAN), a wide area network (WAN), and/or a global area network (GAN), such as the Internet. Additionally, or alternatively, the network 110 may be secure and/or unsecure and may also include wireless and/or wired and/or optical interconnection technology. The network 110 may include one or more wired and/or wireless networks. For example, the network 110 may include a cellular network (e.g., a long-term evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion, or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, storage device 106, a high-speed interface 108 connecting to memory 104, high-speed expansion points 111, and a low-speed interface 112 connecting to a low-speed bus 114, and an input/output (I/O) device 116. The system 130 may also include a high-speed interface 108 connecting to the memory 104, and a low-speed interface 112 connecting to low-speed port 114 and storage device 106. Each of the components 102, 104, 106, 108, 111, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system. The processor 102 may process instructions for execution within the system 130, including instructions stored in the memory 104 and/or on the storage device 106 to display graphical information for a GUI on an external input/output device, such as a display 116 coupled to a high-speed interface 108. In some embodiments, multiple processors, multiple buses, multiple memories, multiple types of memory, and/or the like may be used. Also, multiple systems, same or similar to system 130, may be connected, with each system providing portions of the necessary operations (e.g., as a server bank, a group of blade servers, a multi-processor system, and/or the like). In some embodiments, the system 130 may be managed by an entity, such as a business, a merchant, a financial institution, a card management institution, a software and/or hardware development company, a software and/or hardware testing company, and/or the like. The system 130 may be located at a facility associated with the entity and/or remotely from the facility associated with the entity.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 may store information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 106, or memory on processor 102.

In some embodiments, the system 130 may be configured to access, via the network 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel and/or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, the memory may appear to be allocated from a central pool of memory, even though the memory space may be distributed throughout the system. Such a method of dynamically allocating memory provides increased flexibility when the data size changes during the lifetime of an application and allows memory reuse for better utilization of the memory resources when the data sizes are large.

The high-speed interface 108 manages bandwidth-intensive operations for the system 130, while the low-speed interface 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router (e.g., through a network adapter).

The system 130 may be implemented in a number of different forms. For example, the system 130 may be implemented as a standard server, or multiple times in a group of such servers. Additionally, the system 130 may also be implemented as part of a rack server system or a personal computer (e.g., laptop computer, desktop computer, tablet computer, mobile telephone, and/or the like). Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 156, 158, 160, 162, 164, 166, 168 and 170, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor 152 may be implemented as a chipset of chips that include separate and multiple analog and digital processors. The processor 152 may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156 (e.g., input/output device 156). The display 156 may be, for example, a Thin-Film-Transistor Liquid Crystal Display (TFT LCD) or an Organic Light Emitting Diode (OLED) display, or other appropriate display technology. An interface of the display may include appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a Single In Line Memory Module (SIMM) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner. In some embodiments, the user may use applications to execute processes described with respect to the process flows described herein. For example, one or more applications may execute the process flows described herein. In some embodiments, one or more applications stored in the system 130 and/or the user input system 140 may interact with one another and may be configured to implement any one or more portions of the various user interfaces and/or process flow described herein.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as GSM voice calls, SMS, EMS, or MMS messaging, CDMA, TDMA, PDC, WCDMA, CDMA2000, GPRS, and/or the like. Such communication may occur, for example, through transceiver 160. Additionally, or alternatively, short-range communication may occur, such as using a Bluetooth, Wi-Fi, near-field communication (NFC), and/or other such transceiver (not shown). Additionally, or alternatively, a Global Positioning System (GPS) receiver module 170 may provide additional navigation-related and/or location-related wireless data to user input system 140, which may be used as appropriate by applications running thereon, and in some embodiments, one or more applications operating on the system 130.

Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed application specific integrated circuits (ASICs), computer hardware, firmware, software, and/or combinations thereof.

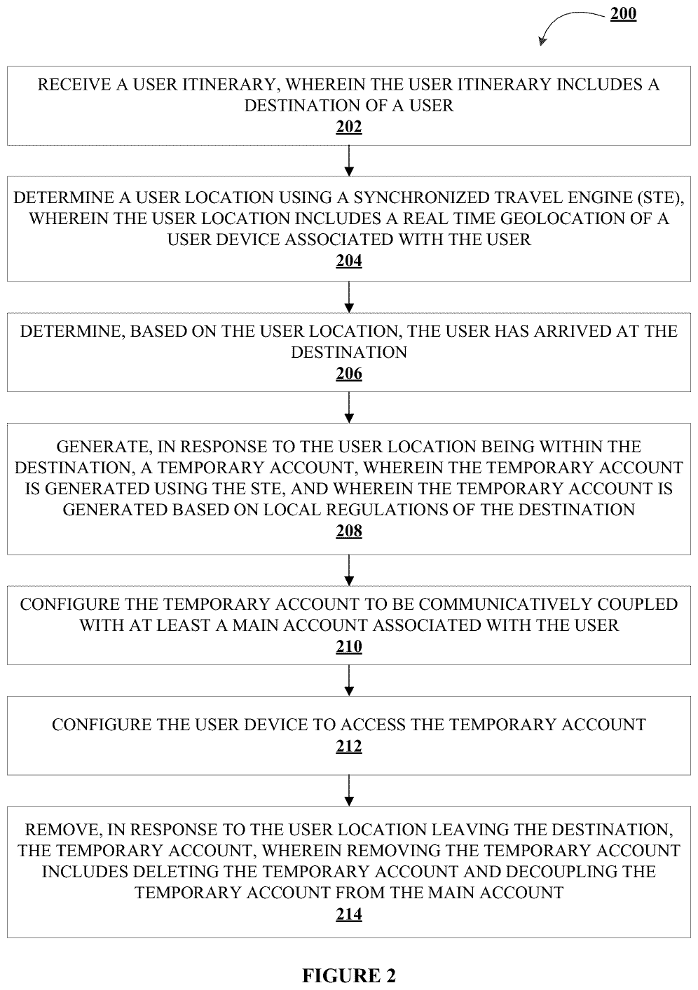

FIG. 2 illustrates a process flow for location dependent instantaneous resource management, in accordance with an embodiment of the disclosure. The method may be carried out by various components of the distributed computing environment 100 discussed herein (e.g., the system 130, one or more end-point device(s) 140, etc.). An example system may include at least one processing device and at least one non-transitory storage device with computer-readable program code stored thereon and accessible by the at least one processing device, wherein the computer-readable code when executed is configured to carry out the method discussed herein.

In some embodiments, a resource management system (e.g., similar to one or more of the systems described herein with respect to FIGS. 1A-1C) may perform one or more of the steps of process flow 200. For example, a resource management system (e.g., the system 130 described herein with respect to FIGS. 1A-1C) may perform the steps of process flow 200.

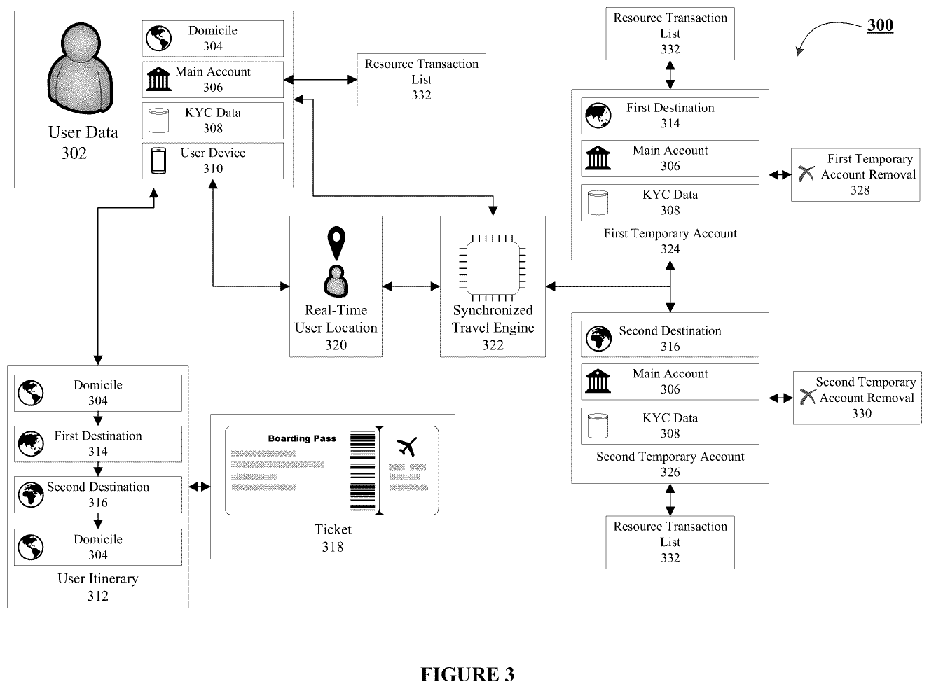

In some embodiments, the synchronized travel engine (STE) may create a temporary account based on user data. As shown in block 202, the process flow 200 of this embodiment includes receiving a user itinerary, wherein the user itinerary includes a destination of the user. The user data may include a user itinerary which may include details about the user's trip. The user may plan a trip via purchasing a ticket, creating a user itinerary, inputting travel destinations to the STE, or the like. The user's trip, which may include the destination the user plans to travel to, may designate how the user may travel to and leave the destination and when the user may arrive to the destination. In some embodiments, the destination may include a country that is different than a domicile of the user, wherein the domicile comprises a home country of the user. Further, in some embodiments, the user itinerary may include a second destination of the user. For example, the user itinerary 312, as shown in FIG. 3, may include the user's domicile 304, the first destination 314, the second destination 316 (if applicable), and the like. In some embodiments, the user itinerary may indicate how the user is going to travel to the destination(s) (e.g., the first destination 314, the second destination 316, etc.) via a ticket 318. The ticket 318 may be, for example, as shown in FIG. 3, a boarding pass, or may be any other ticket, such as a bus ticket, train ticket, or the like. Further, the ticket 318 may include information such as car rental information, hotel reservation information, and the like.

In some embodiments, the resource management system (e.g., the system 130 as described herein) may receive a user itinerary, wherein the user itinerary includes a destination of the user. In some embodiments, the user, via the user device 310, upload the user itinerary 312 to the STE 322. In this way, the user device 310 may be an end-point device 140, as described above and in FIGS. 1A-1C. In this way, the user device 310 may include the same or similar components as described above in relation to the end-point device 140 and in FIGS. 1A-1C. In some embodiments, the user may take pictures, via the user device 310, of the user itinerary 312 or the ticket 318 and input them into the STE 322. Further, in some embodiments, when the user initials books or plans the user's trip, the STE 322 may receive the user itinerary 312 and tickets 318 when the user is booking the trip. In this way, the user device 310 may communicate with the STE 322, the resource management system (e.g., the system 130 as described herein), or the like.

In some embodiments, the ticket 318, along with the user itinerary 312, may be part of the user data 302. This information may be uploaded to the STE 322 in order for the STE 322 to create the user's temporary accounts, as will be discussed in greater detail below. Further, the user data 302 may include the user's domicile 304, the user's main account 306, know-your-customer (KYC) data 308 associated with the user, and the user device 310. The user's domicile 304 may include the user's home country and may be the initial starting point of the user's trip. The main account 306 may be the user's bank account, financial account, or the like that includes the user's resources (e.g., checking account, saving account, investment account, and the like). Further, the main account 306 may be associated with payment instruments that allow the user to management the resources in the main account 306. The KYC data 308 may be data that is used by the STE 322 to create the temporary account. The KYC data 308 may include compliance regulations, rules, laws, and the like that may be used to regulate the user's main account 306, for example. Further, the KYC data 308 may include user-specific information, domicile-specific information, destination-specific information, or the like that may be used to create the temporary accounts. In this way, the KYC data 308 may be used by the STE 322 to create the temporary account(s) of the user based on the temporary account complying with the domicile's 304 rules and regulations. For example, if the domicile 304 includes rules and regulations (e.g., as part of the KYC data 308) governing the user's ability to transact with certain instantaneous payment providers, the STE 322 may use that information to choose a temporary account that complies with the KYC data 308.

As shown in block 204, the process flow 200 of this embodiment includes determining a user location using the STE, wherein the user location includes a real time geolocation of a user device associated with the user. The real time geolocation may be determined by the user device associated with the user. For example, as shown in FIG. 3, the user device 310 may transmit the real-time user location 320 to the STE 322.

As shown in block 206, the process flow 200 of this embodiment includes determining, based on the user location, the user has arrived at the destination. Further, in some embodiments and as shown in FIG. 3, the STE 322 may use the user's real-time location 320 information along with the user itinerary 312 to determine when the user has arrived at the user's destination (e.g., the first destination 314, second destination 316, or the like). For example, the STE 322 may determine that the user has arrived at the first destination 314 when the real-time user location 320 indicates the user is within the borders of the first destination 314. Further, in this example, the STE 322 may also determine that the user is in the first destination 314 based on arrival times associated with the user itinerary 312 and/or the ticket 318.

In some embodiments, the STE 322 determining the user has arrived at the destination (e.g., the first destination 314, the second destination 316, or the like) may be performed in a variety of ways. For example, the STE 322 may determine that the user, based on the real-time user location 320, has crossed into the designated territory of the first destination 314. In this way, as soon as the user's location 320 indicates the user is within the borders of the first destination 314, the STE 322 may determine the user has arrived. In another example, the STE 322 may determine the user is at the first destination 314 when the user's real-time location 320 matches the destination on the user itinerary 312 or the ticket 318. Further, in some embodiments, the user may manually, via the user device 310, indicate to the STE 322 that the user has arrived at the user's destination.

As shown in block 208, the process flow 200 of this embodiment includes generating, in response to the user location being within the destination, a temporary account, wherein the temporary account is generated using the STE, and wherein the temporary account is generated based on local regulations of the destination. For example, as shown in FIG. 3, when the user has arrived at the first destination 314, the STE 322 may generate the first temporary account 324 for the user. The temporary account may be based on where the user is located. For example, and as shown in FIG. 3, the STE 322 may create a first temporary account 324 when the user has arrived in the first destination 314, a second temporary account 326 when the user has arrived in the second destination 316, and so on.

Creating the temporary account may include choosing a provider of accounts associated with the destination. In this way, for example, the STE 322 may pick an account provider that is associated with the destination and that has instantaneous resource transaction capabilities. Further, in some embodiments, generating the temporary account further includes determining local regulations of a domicile of the user, wherein the domicile includes a home country of the user, and wherein the local regulations of the domicile provide guidance for the temporary account. Further still, in some embodiments, generating the temporary account further includes determining local regulations of the destination, wherein the local regulations of the destination provide guidance for the temporary account. In some embodiments, generating the temporary account further includes generating the temporary account based on the local regulations of the domicile and local regulations of the destination. In this way, the temporary account may be chosen based on local laws, rules, regulations, and sanctions of the domicile and the destination country. For example, the STE 322 creating the first temporary account 324 may include selecting an account provider associated with the first destination 314 that is also permitted by the KYC data 308. In other words, the STE 322 may select an account provider that meets conditions set out by the KYC data 308, the domicile 304, and the account provider options of the first destination 314.

As shown in block 210, the process flow 200 of this embodiment includes configuring the temporary account to be communicatively coupled with at least a main account associated with the user. In some embodiments, the communicative coupling between the main account the temporary account may allow resources and data to flow between the accounts. For example, as shown in FIG. 3, after the STE 322 has chosen the provider for the first temporary account 324, the STE 322 may link the first temporary account 324 with the user's main account 306. In this way, the STE 322 may ensure the first temporary account 324 and the main account 306 may communicate with each other as well as transmit resources between the accounts. For example, when the user wishes to transact in the first destination 314, the first temporary account 324 may have access to the user's main account 306 to pull resources and complete the transaction. In some embodiments, the resource management system may couple (e.g., link) the temporary account with other accounts of the user, such as a checking account, savings account, investment account, or the like.

In some embodiments, the first temporary account 324 may be pre-loaded with resources from the main account 306. For example, when the first temporary account 324 is initially created, resources from the main account 306 may be immediately transmitted to the first temporary account 324. In some embodiments, the first temporary account 324 may receive resources from the main account 306 when a transaction is received. In this way, when a transaction is received the first temporary account 324 may signal the main account 306 to transmit resources to the first temporary account 324.

In some embodiments, the user may use the payment instruments associated with the main account 306 to transact resources from the temporary account. In this way, the STE 322 may receive, via the main account 306, a transaction request. The STE 322 may determine the real-time user location 320 is within the first destination 314 and the transaction recipient (e.g., merchant, vendor, payee, etc.) is also in the first destination 314. The STE 322 may then route the payment of resources through the first temporary account 324 to complete the transaction.

As shown in block 212, the process flow 200 of this embodiment includes configuring the user device to access the temporary account. In some embodiments, the STE 322 may configure the user device 310 to interact with the temporary account (e.g., the first temporary account 324, the second temporary account 326, etc.). In some embodiments, the STE 322 may configure a SIM card associated with the user device 310, which may include an e-SIM card. The e-SIM card may enable the user device 310 to interact with the account provider that provides the temporary account. Further, the STE 322 may configure the user device 310 to install software, applications, or the like to enable the user device 310 to interact with the temporary account.

In some embodiments, configuring the user device to access the temporary account may include configuring the temporary account to be secured by one or more security measures, wherein the one or more security measures are the same one or more security measures used to secure the main account. In this way, the user's security settings for the user's main account 306 may carry over to the temporary accounts (e.g., the first temporary account 324, the second temporary account 326, etc.). For example, if a user has passwords, PIN numbers, or other security features, those may transfer to the temporary accounts. In some embodiments, the user may have to input the security features prior to a transaction being completed using the temporary account.

Further, in some embodiments, the user device 310 may be used to complete transactions in the destination country. For example, the user device 310 may be used to pay a vendor in the first destination 314. The STE 322 may confirm the real-time user location 320 is also in the first destination 314. The STE 322 may then move resources from the main account 306 to the first temporary account 324 to complete the transaction.

As shown in block 214, the process flow 200 of this embodiment includes removing, in response to the user location leaving the destination, the temporary account, wherein removing the temporary account includes deleting the temporary account and decoupling the temporary account from the main account. For example, when the user leaves the destination country, the STE may close the temporary account associated with the destination country. As used herein, closing the temporary account may include removing, disabling, eliminating, terminating, and the like the temporary account. The STE removing the temporary account may remove the ability to access the account, remove the ability of the main account to interact with the temporary account, remove any associated software on the user device, and the like.

Removing (e.g., closing, disabling, etc.) the temporary account may be triggered by the user leaving the destination country (e.g., the first destination 314, the second destination 316, or the like). For example, as shown in FIG. 3, the STE 322 may remove the first temporary account 328 when the real-time user location 320 is outside of the first destination 314. Further, in some embodiments, the temporary account removal may be based on the user itinerary 312, the ticket 318, or the like. In some embodiments, removal of the temporary account may include removing the temporary account from the user device 310 and decoupling the communication link between the temporary account and the main account.

In some embodiments, the resource management system (e.g., the system 130) may create a second temporary account 326. If the user is traveling to a second destination 316, the STE 322 may determine a second temporary account 326 should be created. Similar to how the STE 322 created the first temporary account 324, the user data 302 and data relating to the second destination 316 may be used for the second temporary account 326. The second temporary account 326 may be communicatively coupled (e.g., linked) to the main account 306 and the resource transaction list 332 may be updated to show the transactions in the second destination 316. Further, when the user's real-time location 320 indicates the user is no longer in the second destination 316, the second temporary account 326 may be removed 330.

Further, if the user updates the user itinerary 312, the STE 322 may take into account the update. For example, if the user itinerary 312 is updated to show a third destination, the STE 322 may create a third temporary account when the user arrives and remove it when the user leaves (similar to the process described for the first temporary account 324 generation). In this way, the STE 322 may receive continuous updates and update the associated temporary accounts to reflect those updates.

In some embodiments, the present disclosure may generate a resource transaction list, wherein the resource transaction list is associated with the temporary account and includes the resource transactions performed with the temporary account. In some embodiments, the present disclosure may transmit the resource transaction list to the main account, wherein the main account provides for the user to access the resource transaction list after the temporary account has been removed.

For example, after the temporary accounts have been removed, the user may be able to access the transactions carried out via the temporary accounts. The resource transaction list may include the transactions associated with the temporary account(s). For example, and as shown in FIG. 3, the resource transaction list 332 may be created to show the transactions associated with the first temporary account 324 and the transactions associated with the second temporary account 326. The resource transaction list 332 may indicate the resources used for each transaction associated with the temporary accounts and may be accessible after removal of the temporary accounts. In this way, the resource transaction list 332 may be accessible by the main account 306 after the temporary accounts have been removed from the main account 306. Further, the resource transaction list 332 may store the transaction data for report purposes, audit purposes, tax purposes, and the like. In this way, the user may have a record and usage report of the temporary accounts.

Further, in some embodiments, the present disclosure may receive the user itinerary, wherein the user itinerary includes a second destination of the user. In some embodiments, the present disclosure may determine, based on the user location, the user has arrived at the second destination. In some embodiments, the present disclosure may generate, in response to the user location being within the second destination, a second temporary account, wherein the second temporary account is generated using the STE, and wherein the second temporary account is generated based on local regulations of the second destination. In some embodiments, the present disclosure may configure the second temporary account to be communicatively coupled with at least the main account associated with the user. In some embodiments, the present disclosure may configure the user device to access the second temporary account. In some embodiments, the present disclosure may remove, in response to the user location leaving the second destination, the second temporary account, wherein removing the second temporary account comprises deleting the second temporary account and decoupling the second temporary account from the main account.

Further, in some embodiments, the present disclosure may receive an updated user itinerary, wherein the updated user itinerary comprises a new destination of the user. In some embodiments, the present disclosure may determine, based on the user location, the user has arrived at the new destination. In some embodiments, the present disclosure may generate, in response to the user location being within the new destination, a new temporary account, wherein the new temporary account is generated using the STE, and wherein the new temporary account is generated based on local regulations of the new destination. In some embodiments, the present disclosure may configure the new temporary account to be communicatively coupled with at least the main account associated with the user. In some embodiments, the present disclosure may configure the user device to access the new temporary account. In some embodiments, the present disclosure may remove, in response to the user location leaving the new destination, the new temporary account, wherein removing the new temporary account comprises deleting the new temporary account and decoupling the new temporary account from the main account.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for location dependent instantaneous resource management, the system comprising:
a processing device;
a non-transitory storage device containing instructions when executed by the processing device, causes the processing device to perform the steps of:
receive a user itinerary, wherein the user itinerary comprises a destination of a user;
determine a user location using a synchronized travel engine (STE), wherein the user location comprises a real time geolocation of a user device associated with the user;
determine, based on the user location, the user has arrived at the destination;
generate, in response to the user location being within the destination, a temporary account, wherein the temporary account is generated using the STE, and wherein the temporary account is generated based on local regulations of the destination;
configure the temporary account to be communicatively coupled with at least a main account associated with the user;
configure the user device to access the temporary account; and
remove, in response to the user location leaving the destination, the temporary account, wherein removing the temporary account comprises deleting the temporary account and decoupling the temporary account from the main account.

2. The system of claim 1, wherein executing the instructions further causes the processing device to:
receive the user itinerary, wherein the user itinerary comprises a second destination of the user;
determine, based on the user location, the user has arrived at the second destination;
generate, in response to the user location being within the second destination, a second temporary account, wherein the second temporary account is generated using the STE, and wherein the second temporary account is generated based on local regulations of the second destination;
configure the second temporary account to be communicatively coupled with at least the main account associated with the user;
configure the user device to access the second temporary account; and
remove, in response to the user location leaving the second destination, the second temporary account, wherein removing the second temporary account comprises deleting the second temporary account and decoupling the second temporary account from the main account.

3. The system of claim 1, wherein executing the instructions further causes the processing device to:
receive an updated user itinerary, wherein the updated user itinerary comprises a new destination of the user;
determine, based on the user location, the user has arrived at the new destination;
generate, in response to the user location being within the new destination, a new temporary account, wherein the new temporary account is generated using the STE, and wherein the new temporary account is generated based on local regulations of the new destination;
configure the new temporary account to be communicatively coupled with at least the main account associated with the user;
configure the user device to access the new temporary account; and
remove, in response to the user location leaving the new destination, the new temporary account, wherein removing the new temporary account comprises deleting the new temporary account and decoupling the new temporary account from the main account.

4. The system of claim 1, wherein generating the temporary account further comprises:
determining local regulations of a domicile of the user, wherein the domicile comprises a home country of the user, and wherein the local regulations of the domicile provide guidance for the temporary account;
determining local regulations of the destination, wherein the local regulations of the destination provide guidance for the temporary account; and
generating the temporary account based on the local regulations of the domicile and local regulations of the destination.

5. The system of claim 1, wherein the destination comprises a country that is different than a domicile of the user, wherein the domicile comprises a home country of the user.

6. The system of claim 1, wherein configuring the user device to access the temporary account further comprises configuring the temporary account to be secured by one or more security measures, wherein the one or more security measures are the same one or more security measures used to secure the main account.

7. The system of claim 1, wherein executing the instructions further causes the processing device to:
generate a resource transaction list, wherein the resource transaction list is associated with the temporary account and includes the resource transactions performed with the temporary account; and
transmit the resource transaction list to the main account, wherein the main account provides for the user to access the resource transaction list after the temporary account has been removed.

8. A computer program product for location dependent instantaneous resource management, the computer program product comprising a non-transitory computer-readable medium comprising code causing an apparatus to:
receive a user itinerary, wherein the user itinerary comprises a destination of a user;
determine a user location using a synchronized travel engine (STE), wherein the user location comprises a real time geolocation of a user device associated with the user;
determine, based on the user location, the user has arrived at the destination;
generate, in response to the user location being within the destination, a temporary account, wherein the temporary account is generated using the STE, and wherein the temporary account is generated based on local regulations of the destination;
configure the temporary account to be communicatively coupled with at least a main account associated with the user;
configure the user device to access the temporary account; and
remove, in response to the user location leaving the destination, the temporary account, wherein removing the temporary account comprises deleting the temporary account and decoupling the temporary account from the main account.

9. The computer program product of claim 8, wherein the code further causes the apparatus to:
receive the user itinerary, wherein the user itinerary comprises a second destination of the user;
determine, based on the user location, the user has arrived at the second destination;
generate, in response to the user location being within the second destination, a second temporary account, wherein the second temporary account is generated using the STE, and wherein the second temporary account is generated based on local regulations of the second destination;
configure the second temporary account to be communicatively coupled with at least the main account associated with the user;
configure the user device to access the second temporary account; and
remove, in response to the user location leaving the second destination, the second temporary account, wherein removing the second temporary account comprises deleting the second temporary account and decoupling the second temporary account from the main account.

10. The computer program product of claim 8, wherein the code further causes the apparatus to:
receive an updated user itinerary, wherein the updated user itinerary comprises a new destination of the user;
determine, based on the user location, the user has arrived at the new destination;
generate, in response to the user location being within the new destination, a new temporary account, wherein the new temporary account is generated using the STE, and wherein the new temporary account is generated based on local regulations of the new destination;
configure the new temporary account to be communicatively coupled with at least the main account associated with the user;
configure the user device to access the new temporary account; and
remove, in response to the user location leaving the new destination, the new temporary account, wherein removing the new temporary account comprises deleting the new temporary account and decoupling the new temporary account from the main account.

11. The computer program product of claim 8, wherein generating the temporary account further comprises:
determining local regulations of a domicile of the user, wherein the domicile comprises a home country of the user, and wherein the local regulations of the domicile provide guidance for the temporary account;
determining local regulations of the destination, wherein the local regulations of the destination provide guidance for the temporary account; and
generating the temporary account based on the local regulations of the domicile and local regulations of the destination.

12. The computer program product of claim 8, wherein the destination comprises a country that is different than a domicile of the user, wherein the domicile comprises a home country of the user.

13. The computer program product of claim 8, wherein configuring the user device to access the temporary account further comprises configuring the temporary account to be secured by one or more security measures, wherein the one or more security measures are the same one or more security measures used to secure the main account.

14. The computer program product of claim 8, wherein the code further causes the apparatus to:
generate a resource transaction list, wherein the resource transaction list is associated with the temporary account and includes the resource transactions performed with the temporary account; and
transmit the resource transaction list to the main account, wherein the main account provides for the user to access the resource transaction list after the temporary account has been removed.

15. A method for location dependent instantaneous resource management, the method comprising:
receiving a user itinerary, wherein the user itinerary comprises a destination of a user;
determining a user location using a synchronized travel engine (STE), wherein the user location comprises a real time geolocation of a user device associated with the user;
determining, based on the user location, the user has arrived at the destination;
generating, in response to the user location being within the destination, a temporary account, wherein the temporary account is generated using the STE, and wherein the temporary account is generated based on local regulations of the destination;
configuring the temporary account to be communicatively coupled with at least a main account associated with the user;
configuring the user device to access the temporary account; and
removing, in response to the user location leaving the destination, the temporary account, wherein removing the temporary account comprises deleting the temporary account and decoupling the temporary account from the main account.

16. The method of claim 15, wherein the method further comprises:
receiving the user itinerary, wherein the user itinerary comprises a second destination of the user;
determining, based on the user location, the user has arrived at the second destination;
generating, in response to the user location being within the second destination, a second temporary account, wherein the second temporary account is generated using the STE, and wherein the second temporary account is generated based on local regulations of the second destination;
configuring the second temporary account to be communicatively coupled with at least the main account associated with the user;
configuring the user device to access the second temporary account; and
removing, in response to the user location leaving the second destination, the second temporary account, wherein removing the second temporary account comprises deleting the second temporary account and decoupling the second temporary account from the main account.

17. The method of claim 15, wherein the method further comprises:
receiving an updated user itinerary, wherein the updated user itinerary comprises a new destination of the user;
determining, based on the user location, the user has arrived at the new destination;
generating, in response to the user location being within the new destination, a new temporary account, wherein the new temporary account is generated using the STE, and wherein the new temporary account is generated based on local regulations of the new destination;
configuring the new temporary account to be communicatively coupled with at least the main account associated with the user;
configuring the user device to access the new temporary account; and
removing, in response to the user location leaving the new destination, the new temporary account, wherein removing the new temporary account comprises deleting the new temporary account and decoupling the new temporary account from the main account.

18. The method of claim 15, wherein generating the temporary account further comprises:
determining local regulations of a domicile of the user, wherein the domicile comprises a home country of the user, and wherein the local regulations of the domicile provide guidance for the temporary account;
determining local regulations of the destination, wherein the local regulations of the destination provide guidance for the temporary account; and
generating the temporary account based on the local regulations of the domicile and local regulations of the destination.

19. The method of claim 15, wherein the destination comprises a country that is different than a domicile of the user, wherein the domicile comprises a home country of the user.

20. The method of claim 15, wherein the method further comprises:
generating a resource transaction list, wherein the resource transaction list is associated with the temporary account and includes the resource transactions performed with the temporary account; and
transmitting the resource transaction list to the main account, wherein the main account provides for the user to access the resource transaction list after the temporary account has been removed.
